(19) United States
(12) Patent Application Publication
(10) Pub. No.: US 2011/0305619 A1
(43) Pub. Date: Dec. 15, 2011

(54) Silicon Containing Halogenide, Method for Producing the Same, and Use of the Same

(75) Inventors: Seyed-Javad Mohsseni-Ala, Bitterfeld-Wolfen (DE); Christian Bauch, Bitterfeld-Wolfen (DE); Thoralf Gebel, Dresden (DE); Rumen Deltschew, Leipzig (DE); Gerd Lippold, Leipzig (DE); Norbert Auner, Glashutten (DE)

(73) Assignee: Spawnt Private S.a.r.l

(21) Appl. No.: 12/995,136

(22) PCT Filed: May 27, 2009
(86) PCT No.: PCT/DE2009/000728

§ 371 Date: Mar. 18, 2011

(30) Foreign Application Priority Data
May 27, 2008 (DE) 102008025263.8
May 27, 2008 (DE) 102008025264.6

(51) Int. Cl. C01B 33/037; C01B 33/08; B32B 5/16

(52) U.S. Cl. 423/341; 428/402; 423/348

(57) ABSTRACT

The invention relates to silicon containing halogenide obtained by thermal disintegration of halogenized polysilane, and a method for producing the silicon. The silicon has a halogenide content of 1 at %-50 at %. The invention further relates to the use of the silicon containing halogenide for purifying metallurgical silicon.

The present invention relates to silicon obtained by thermal decomposition of halogenated polysilane in particular silicon obtained by thermal decomposition of chlorinated polysilane.

WO 2006/125425 A1 discloses a method for producing silicon from halosilanes, wherein, in a first step, the halosilane is converted into a halogenated polysilane with generation of a plasma discharge, said halogenated polysilane subsequently being decomposed in a second step with heating to form silicon. For the decomposition of the halogenated polysilane, the latter is preferably heated to a temperature of 400° C. to 1500° C. Temperatures of 800° C., 700° C., 900° C. and once again 800° C. are used in the exemplary embodiments. As far as the pressure used is concerned, reduced pressure is preferably employed, vacuum being employed in the exemplary embodiments.

It goes without saying that the production of silicon that is as pure as possible is striven for with the method described above. In particular, the silicon obtained has a low halide content.

The, present invention is based on the object of providing a silicon variant obtained by thermal decomposition of halogenated polysilane, which variant can be used, in particular, for silicon purification purposes. Furthermore, the intention is to provide a method for producing such a silicon variant.

The object mentioned above is achieved according to the invention by means of halide-containing silicon obtained by thermal decomposition of halogenated polysilane and having a halide content of 1 at %-50 at %.

It has been established according to the invention that the high temperatures and low pressures used in the known method for producing silicon as described in the introduction are responsible for the high purity of the end product obtained, in particular with regard to the halide content of the end product. The invention now does not strive to produce silicon having a halide content that is as low as possible, rather the silicon is intended to have, in a targeted manner, a relatively high halide content of 1 at %-50 at %. This silicon having a relatively high halide content is made possible by relative low temperatures and relatively high pressures during the thermal decomposition (pyrolysis).

The silicon obtained by thermal decomposition of halogenated polysilane is preferably obtained directly in granular form. It preferably has a bulk density of 0.2-1.5 g/cm³, furthermore preferably a grain size of 50-20,000 μm.

It has been established that the halide content is dependent on the grain size. The halide content increases as the grain size grows.

The halide content can be determined quantatively by titration using silver nitrate (according to Moor). IR spectroscopic measurements (ATR technique, diamond single reflection) on chloride-containing silicon show a signal at 1029 cm⁻¹. The intensity is dependent on the halide content and increases as the halide content increases.

Whereas, therefore, in the prior art presented in the introduction, the method conditions (pyrolysis conditions) are selected such that silicon that is as pure as possible is obtained, the silicon according to the invention has, in a targeted manner, a relatively high halide content.

As far as the halide content of the silicon is concerned, the latter comprises, for example, halosilanes (SiₙX₂ₙ₊₂ (X=halogen)) in the vacancies of halogen-containing silicon grains. Said halosilanes can be present in a physical mixture with the silicon grains. However, the silicon can also comprise halogen chemically fixedly bonded to Si atoms, wherein the silicon according to the invention normally includes both variants.

The color of the silicon according to the invention is dependent on the halide content (chloride content). By way of example, silicon having a chloride content of 30 at % is reddish brown, while silicon having a chloride content of 5 at % is blackish grey.

The present invention furthermore relates to a method for producing the granular silicon according to the invention, wherein the halogenated polysilane is thermally decomposed with continuous addition in a reactor. Preferably, in this case, the halogenated polysilane is introduced into the reactor dropwise. The relatively high halide content desired according to the invention is obtained by means of this continuous procedure.

In this case, the thermal decomposition preferably takes place in a temperature range of 350° C.-1200° C., wherein the temperature for the decomposition of the halogenated polysilane is preferably less than 400° C.

Furthermore, the thermal decomposition is preferably carried out at a pressure of 10⁻³ mbar to 300 mbar above atmospheric pressure, wherein pressures >100 mbar are preferred.

In one variant of the method according to the invention, an inert gas atmosphere, in particular argon atmosphere, is maintained in the reactor used for the thermal decomposition.

The setting of the desired halide content is possible by variation of a series of parameters, for example setting a desired time profile, temperature profile and pressure profile. As already mentioned, in the method according to the invention, the halide-containing silicon is preferably obtained directly in granular form. This does not, of course, rule out the possibility of correspondingly modifying the obtained end product by means of further mechanical measures such as mechanical comminution, screening, etc. in order to obtain desired material properties in specific regions.

A further method variant for setting the halide content of the granular silicon obtained concerns an aftertreatment of the silicon obtained. By way of example, the halide content can be reduced by baking. Thus, by way of example, the chloride content of a specific silicon type (grain size 50 μm to 20,000 μm, chloride content 15%) was reduced to 4% by baking to 1150° C. over four hours. By way of example, baking, baking under vacuum, comminution or screening shall be mentioned as suitable aftertreatment.

The present invention furthermore relates to the use of the halide-containing silicon for purifying metallurgical silicon.

U.S. Pat. No. 4,312,849 discloses a method for removing phosphorous impurities in a method for purifying silicon, where a silicon melt is produced and the melt is treated with a chlorine source in order to remove phosphorous. The preferred chlorine source used is a gaseous chlorine source, in particular Cl₂. COCl₂ and CCl₄ are indicated as other chlorine sources. Aluminum is additionally added to the melt. The gas containing the chlorine source is bubbled through the melt.

DE 29 29 089 A1 discloses a method for refining and growing silicon crystals, wherein a gas is caused to react with a silicon melt, wherein the gas is selected from the group comprising wet hydrogen, chlorine gas, oxygen and hydrogen chloride.

EP 0 007 063 A1 describes a method for producing polycrystalline silicon, wherein a mixture of carbon and silicon is heated to form a melt and a gas containing chlorine and oxygen is conducted through the melt.

As shown by the explanations above, it is already known to remove impurities from silicon melts with the aid of gaseous chlorine sources. In this case, gas mixtures containing chlorine gas or chlorine are introduced into the Si melt. The implementation of such technology is very complex, however, since the chlorine has to be introduced directly into the melt, which is generally effected by means of small tubes or special nozzles. Therefore a homogeneous distribution of the chlorine over the entire melt is only possible to a limited extent. Moreover, the apparatuses for introducing the chlorine into the melt can adversely affect the melt itself, that is to say that impurities originating from the apparatuses for introducing gas can occur, for example.

It has now been found that the halide-containing silicon according to the invention is excellently suitable for purifying metallurgical silicon, to be precise in a particularly simple and effective manner. In this case, in a first variant, a procedure is carried out comprising the following steps:
mixing halide-containing silicon with the metallurgical silicon to be purified;
melting the mixture and thereby sublimating out the impurities and removing the same from the melt in the form of metal halides.

Consequently, rather than the use of a gaseous chlorine source for purifying the metallurgical silicon, as is the case in the prior art, solid halide-containing silicon is mixed with the metallurgical silicon to be purified, and the resulting mixture is melted. As a result, the impurities, in particular heavy metals in the form of chlorides, for example FeCl₃, are sublimated out and thus removed from the melt.

In a second variant of the use according to the invention, a procedure is carried out comprising the following steps:
melting the metallurgical silicon to be purified;
introducing halide-containing silicon into the melt and thereby sublimating out the impurities and removing the same from the melt in the form of metal halides.

In this second method variant, therefore, prior mixing of the halide-containing silicon with the metallurgical silicon to be purified does not take place, rather the halide-containing silicon is introduced directly into a melt composed of the metallurgical silicon to be purified. By this means, too, impurities of the silicon to be purified are sublimated out and removed from the melt in the form of metal halides.

In this case, the halide-containing silicon used is preferably chloride-containing silicon.

The halide-containing silicon used can preferably be halide-containing silicon which contains halosilane fractions mixed with Si fractions. Such halosilanes (SiₙX₂ₙ₊₂, where X denotes halogen and n denotes 1-10, preferably 1-3) are preferably present (physically) in the vacancies of chlorine-containing silicon grains, but can also be fixedly bonded to silicon atoms (Si—X) by chemical bonds.

The corresponding halide content can be determined quantitatively by titration using silver nitrate (according to Moor). IR-spectroscopic measurements (ATR technique, diamond single reflection) on chloride-containing silicon show a signal at 1029 cm⁻¹. The intensity is dependent on the halide content and increases as the halide content increases.

In order to achieve good mixing of the halide-containing silicon with the metallurgical silicon to be purified, preferably granular, in particular fine-grained halogen-containing silicon is used. In this case, the grain size is expediently 50 μm to 20,000 μm. The halide-containing silicon preferably has a bulk density of 0.2 g/cm³ to 1.5 g/cm³.

The halide content is dependent on the grain size. The halide content increases as the grain size grows.

A further variant of the method according to the invention is distinguished by the fact that the halide content of the halide-containing silicon used for purification is set by means of aftertreatment. Said aftertreatment preferably takes place under vacuum. By way of example, the chloride content of chloride-containing silicon of a specific type (grain size 50 μm to 20,000 μm (without screening) chloride content 15%) was reduced to a chloride content of 4% by baking to 1150° C. over 4 hours. Suitable aftertreatment methods include, for example, baking, baking under vacuum, comminution or screening.

It has been found that good results with regard to the purification of metallurgical silicon can be achieved according to the invention without complicated devices for introducing gas into the melt. In this case, in particular, heavy metals in the form of chlorides were able to be removed from the melt in a completely satisfactory manner.

In a further embodiment of the use according to the invention, the melt is replenished with halide-containing silicon. In this case, “melt” is taken to mean the melt consisting of the mixture of halide-containing silicon and silicon to be purified, or the melt consisting solely of silicon to be purified. In both cases, by means of the “replenishing” performed, the corresponding purification process can be set, for example readjusted or begun anew.

Yet another embodiment of the use of the invention is distinguished by the fact that the melt is homogenized. This can be effected, for example, by means of agitation of the melt, in particular by crucible rotation, use of a stirrer, etc. However, the melt can also be homogenized simply by being allowed to stand for a sufficient time, such that suitable homogenization arises by convection in this case.

The purification according to the invention can be used, in particular, in Si crystallization methods, for example in ingot casting methods, Czochralski methods, EFG methods, string ribbon methods, RSG methods. In this case, it is used for purifying the Si melt from which the crystals are produced. In the ingot casting method, multicrystalline Si ingots are produced by crystals with a width of up to a plurality of centimeters being allowed to grow through the entire ingot by means of controlled solidification. In the EFG method (edge-defined film growth) an octagonal “tube” is pulled from the silicon melt. The resulting multicrystalline tube is sawn at the edges and processed to form wafers. In the string ribbon method, between two wires a ribbon is pulled from the silicon melt. In the RGS method (ribbon growth on substrate) a ribbon of silicon arises by a carrier material being moved under a crucible with liquid silicon. The Czochralski method is a method for producing silicon single crystals wherein a crystal is pulled from the silicon melt. Under pulling and rotational movements, a cylindrical silicon single crystal deposits on a crystalline seed.

### EXEMPLARY EMBODIMENT

Halogenated polysilane produced plasma-chemically in the form of PCS was continuously introduced dropwise into a reactor, the reaction zone of which was kept at a pressure of 300 mbar. The temperature of the reaction zone was kept at 450° C. A solid granular end product obtained was continuously extracted from the reactor, said end product being silicon having a chloride content of 33 at %. The chloride-containing silicon obtained had a bulk density of 1.15 g/cm³ and a red color.

1. A Halide-containing silicon obtained by thermal decomposition of halogenated polysilane and having a halide content of 1 at %-50 at %.

2. The halide-containing silicon according to claim 1, wherein it is in granular form.

3. The halide-containing silicon according to claim 1, wherein it has a bulk density of 0.2-1.5 g/cm³.

4. The halide-containing silicon according to claim 1, wherein it has a grain size of 50-20,000 μm.

5. The halide-containing silicon according to claim 1, wherein it comprises halosilanes (SiₙX₂ₙ₊₂ (X=halogen)) in the voids of halogen-containing silicon grains.

6. The halide-containing silicon according to claim 1, wherein it comprises halogen chemically bonded to Si atoms.

7. The halide-containing silicon according to claim 1, wherein it contains chloride.

8. A method for producing the halide-containing silicon comprising the step of thermally decomposing the halogenated polysilane with continuous addition of the halogenated polysilane in a reactor.

9. The method according to claim 8, characterized in that the halogenated polysilane is introduced into the reactor dropwise.

10. The method according to claim 8, wherein the thermal decomposition takes place in a temperature range of 350° C.-1200° C.

11. The method according to claim 10, wherein the temperature for the decomposition of the halogenated polysilane is less than 400° C.

12. The method according to according to claim 8, wherein the thermal decomposition takes place at a pressure of 10⁻³ mbar to 300 mbar above atmospheric pressure.

13. The method according to according to claim 8, wherein an inert gas atmosphere, is maintained in the reactor used for the thermal decomposition.

14. The method according to according to claim 8, wherein the halide content of the halide-containing silicon obtained is set by aftertreatment of said halide-containing silicon.

15. The use of the halide-containing silicon according to claim 8, for purifying metallurgical silicon, comprising one of:
mixing halide-containing silicon with the metallurgical silicon to be purified and melting the mixture and
melting the metallurgical silicon to be purified and introducing halide-containing silicon into the melt,
thereby sublimating out the impurities and removing the same from the melt in the form of metal halides.

16. The use of the halide-containing silicon according to any of claims 1 to 14 for purifying metallurgical silicon, comprising the following steps:
melting the metallurgical silicon to be purified;
introducing halide-containing silicon into the melt and thereby sublimating out the impurities and removing the same from the melt in the form of metal halides.

17. The method according to claim 15, characterized in that the halide-containing silicon used is halide-containing silicon which contains halosilane fractions mixed with Si fractions.

18. The method according to claims 15, characterized in that the halide-containing silicon used is halide-containing silicon which contains halogen chemically bonded to Si atoms.

19. The method according to claims 15, characterized in that granular, in particular fine-grained halide-containing silicon is used.

20. The method according to any of claims 15, characterized in that the melt is replenished with halide-containing silicon.

21. The method according to claims 15, characterized in that the melt is homogenized.

22. The method according to claims 15, characterized in that it is used in Si crystallization methods, in particular ingot casting methods, Czochralski methods, EFG methods, string ribbon methods, RSG methods.

23. Purified silicon produced by the method of claim 15.
